(19) United States
(12) Patent Application Publication
(10) Pub. No.: US 2024/0381907 A1
(43) Pub. Date: Nov. 21, 2024

(54) DEVICE FOR STORING A LIQUID THAT CAN BE ALTERED BY OXYGEN

(71) Applicant: WINEFIT S.R.L., Poggibonsi (IT)

(72) Inventors: Rahhali SANHAJI, Sesto Fiorentino (IT); Stefano PALO, Azzate (IT)

(73) Assignee: WINEFIT S.R.L., Poggibonsi (IT)

(21) Appl. No.: 18/692,752

(22) PCT Filed: Sep. 10, 2022
(86) PCT No.: PCT/IB2022/058543

§ 371 Date: Mar. 15, 2024

(30) Foreign Application Priority Data
Sep. 15, 2021 (IT) 102021000023780
Jun. 3, 2022 (IT) 102022000011786

(51) Int. Cl. A23L 3/3418; A23L 3/00

(52) U.S. Cl. CPC A23L 3/3418; A23L 3/001; A23L 3/003

(57) ABSTRACT

A device for preserving a liquid inside a container comprising a pressurizing circuit to pressurize the container, said pressurizing circuit comprising a fastening element to connect the pressurizing circuit to a source of inert gas, a pressure switch and an injection duct for introducing the inert gas in the container. The device comprises a solenoid valve EV1 to switch between an open configuration and a closed configuration. The device comprises an electric switch to bring the solenoid valve EV1 in the open configuration when the injection duct is connected to the container and to bring the solenoid valve EV1 in the closed configuration when the injection duct is not connected to the container. The device comprises a control unit to bring the solenoid valve EV1 in the closed configuration when the pressure switch verifies a pressure in the container higher than a predetermined threshold value.

### FIELD OF THE INVENTION

The present invention relates to the field of preserving liquids and foods that can be altered by oxygen, in particular wine.

### DESCRIPTION OF THE PRIOR ART

There are known devices for storing bottles of wine, or other liquids that can be altered by oxygen, after their partial consumption. In particular, these devices provide for the conservation of these bottles under vacuum or using inert gases (e.g. CO₂, Ar, N₂ or a combination of these), in order to preserve, even for a long time, the organoleptic properties of the wine itself which, as known, they are altered in contact with the oxygen present in the environment.

These devices generally comprise a cap applicable to the mouth of a bottle, which is equipped with a non-return valve that allows to suck air from the bottle or to introduce an inert gas inside. The extraction of air and the introduction of inert gas can also be combined and implemented by a single device. In particular, both the introduction of the inert gas into the bottle, and the subtraction of oxygen for the formation of the vacuum inside it, generally involve the use of relative spring switches that allow the interruption of the flow, in one direction or in the other, once the desired condition has been reached.

However, such switches can be subject to malfunction. In the case of devices that inject gas into the bottle, this entails the possibility of gas dispersion into the environment in quantities that are also harmful to the operators. In the case of devices that extract oxygen from the bottle, this can lead to the creation of an excessive vacuum level, with consequent aspiration of sulfur dioxide SO₂ and dissolved carbon dioxide CO₂, altering the original taste of the wine.

### SUMMARY OF THE INVENTION

It is therefore a feature of the present invention to provide a device for preserving a liquid inside a container, in particular wine, which allows storage by introducing inert gas and/or by subtracting oxygen from the bottle.

It is also a feature of the present invention to provide such a device that prevents the dispersion of gas in the external environment.

It is still a feature of the present invention to provide such a device that guarantees a pressure in the bottle suitable for correct storage of the liquid.

It is still a feature of the present invention to provide such a device that avoids the formation of an excessive vacuum in the bottle.

It is a further feature of the present invention to provide such a device that allows the preservation of food by subtracting oxygen from a food container.

These and other objects are achieved by a device for preserving a liquid inside a container, said device comprising a pressurizing circuit arranged to pressurize said container, said pressurizing circuit comprising:
a fastening element arranged to connect said pressurizing circuit to a source of inert gas;
a pressure switch;
an injection duct arranged to be connected to said container for introducing said inert gas in said container;
a solenoid valve EV1 arranged to switch between an open configuration, in which said injection duct allows the introduction of said inert gas in said container, and a closed configuration, in which said injection duct does not allow the introduction of said inert gas in said container;
an electric switch arranged to bring said solenoid valve EV1 in said open configuration, when said injection duct is connected to said container, and to bring said solenoid valve EV1 in said closed configuration, when said injection duct is not connected to said container;
a control unit arranged to bring said solenoid valve EV1 in said closed configuration when said pressure switch verifies a pressure in said container higher than a predetermined threshold value Pₘₐₓ;
whose main feature is that said control unit is also arranged to bring said solenoid valve EV1 in said closed configuration if said solenoid valve EV1 remains in said open configuration for a time longer than a predetermined threshold value tₘₐₓ.

Therefore, the present invention provides that the solenoid valve EV1 is brought into the closed configuration alternatively:
in case that the container is disconnected from the injection duct;
in case that the pressure in the container exceeds a predetermined threshold value Pₘₐₓ;
in case that the solenoid valve EV1 remains in the open configuration for a time longer than a predetermined threshold value tₘₐₓ.

In this way, the present invention allows to obtain the correct pressure inside the container while avoiding the dispersion of inert gas in the event of component malfunction.

In fact, in case of correct operation, the pressure switch blocks the entry of inert gas (CO₂) into the container when the desired pressure has been reached.

In case, instead, that there is a malfunction in the pressure switch and/or in the event that the container is removed prematurely and there is a malfunction in the electric switch, the control unit in any case blocks the flow of inert gas avoiding its dispersion into the environment.

Advantageously, said pressurizing circuit also comprises a pressure reducer arranged to adjust the pressure of inert gas in said pressurizing circuit.

In particular, said pressurizing circuit also comprises a flow reducer arranged to prevent pressure peaks in said pressurizing circuit.

In this way, it is avoided that a pressure peak in the circuit causes the pressure switch to be activated by mistake, by controlling the closure of the solenoid valve when the inert gas pressure in the container is not yet sufficient.

In particular, said inert gas is carbon dioxide CO₂.

According to another aspect of the invention, a device for preserving a liquid inside a container is claimed, said device comprising a suction circuit arranged to reduce the pressure in said container, said suction circuit comprising:
a fastening element arranged to connect said suction circuit to a vacuum pump;
a vacuum switch;
a suction duct arranged to be connected to said container for causing the suction of gas from said container;
a solenoid valve EV2 arranged to switch between an open configuration, in which said suction duct allows the suction of gas from said container, and a closed configuration, in which said suction duct does not allow the suction of gas from said container;
an electric switch arranged to bring said solenoid valve EV2 in said open configuration, when said suction duct is connected to said container, and to bring said solenoid valve EV2 in said closed configuration, when said suction duct is not connected to said container;
a control unit arranged to bring said solenoid valve EV2 in said closed configuration when said vacuum switch verifies a pressure in said container lower than a predetermined threshold value Pₘᵢₙ;
whose main feature is that said control unit is also arranged to bring said solenoid valve EV2 in said closed configuration if said solenoid valve EV2 remains in said open configuration for a time longer than a predetermined threshold value tₘₐₓ.

Therefore, the present invention provides that the solenoid valve EV2 is brought into the closed configuration alternatively:
in case that the container is disconnected from the suction duct;
in case that the pressure in the container is lower than a predetermined threshold value Pₘᵢₙ;
in case that the solenoid valve EV2 remains in the open configuration for a time longer than a predetermined threshold value tₘₐₓ.

In this way, the present invention allows to obtain the correct removal of gas from the container while avoiding the creation of an excessive vacuum in case of malfunction of the vacuum switch.

In fact, in case of correct operation, the vacuum switch blocks the aspiration of gas (oxygen) from the container when the desired vacuum level has been reached.

In case, instead, that there is a malfunction of the vacuum switch, the control unit in any case blocks the suction of gas, avoiding the formation of a high vacuum which would involve the suction of sulfur dioxide SO2 and dissolved carbon dioxide CO2, altering the original taste of the wine.

Advantageously, an adapter is also provided for the connection between the suction duct and a food container arranged at generate the vacuum inside, in order to suck in the gas by the food container.

According to a further aspect of the invention, a device for preserving a liquid inside a container is claimed, said device comprising:
a pressurizing circuit according to any of claims from 1 to 4;
a suction circuit according to claim 5.

In a possible embodiment of the invention, the device is designed to be recessed into a wall, reducing the overall footprint and being optimal for insertion inside, for example, a domestic kitchen.

According to a further aspect of the invention, a device for preserving a liquid inside a container is claimed, said device comprising a suction circuit arranged to reduce the pressure in said container, said suction circuit comprising:
a vacuum switch;
a suction duct arranged to be connected to said container for causing the suction of gas from said container;
a vacuum pump connected to said suction circuit by means of a fastening element, said vacuum pump arranged to switch between an open configuration, in which said suction duct allows the suction of gas from said container, and a closed configuration, in which said suction duct does not allow the suction of gas from said container;
an electric switch arranged to bring said vacuum pump in said open configuration, when said suction duct is connected to said container, and to bring said vacuum pump in said closed configuration, when said suction duct is not connected to said container;
a control unit arranged to bring said vacuum pump in said closed configuration when said vacuum switch verifies a pressure in said container lower than a predetermined threshold value Pₘᵢₙ;
whose main feature is that said control unit is also arranged to bring said vacuum pump in said closed configuration if said vacuum pump remains in said open configuration for a time longer than a predetermined threshold value tₘₐₓ.

In this embodiment, therefore, the suction circuit does not comprise the solenoid valve EV2, but it is the vacuum pump to switch between the open configuration and the closed configuration.

### BRIEF DESCRIPTION OF THE DRAWINGS

The invention will be now shown with the following description of its exemplary embodiments, exemplifying but not limitative, with reference to the attached drawings in which:

FIG. 1 shows a hydraulic diagram of the pressurizing circuit of the device according to the present invention;

FIG. 2 shows a block diagram of the operation of the pressurizing circuit of the device according to the present invention;

FIG. 3 shows a hydraulic diagram of the suction circuit of the device according to the present invention;

FIG. 4 shows a block diagram of the operation of the suction circuit of the device according to the present invention;

FIG. 5 shows a possible exemplary embodiment of the device for preserving a liquid inside a container, where the container is connected to the pressurizing circuit;

FIG. 6 shows a possible embodiment of the device for preserving a liquid inside a container, where the container is connected to the suction circuit;

FIG. 7 shows a possible exemplary embodiment of the invention where the device for preserving a liquid is arranged for being recessed into a wall;

FIG. 7A shows an exemplary embodiment of FIG. 7, highlighting the method of installation inside a wall;

FIGS. 8A and 8B show an exemplary embodiment of FIG. 7 where the container is connected, respectively, to the pressurizing circuit and to the suction circuit;

FIGS. 9 and 9A show an exemplary embodiment of FIG. 7 in the mode of use for creating vacuum in a food container;

FIG. 10 shows a block diagram of the operation of the suction circuit, in the mode of use for creating vacuum in a food container.

### DESCRIPTION OF SOME PREFERRED EXEMPLARY EMBODIMENTS

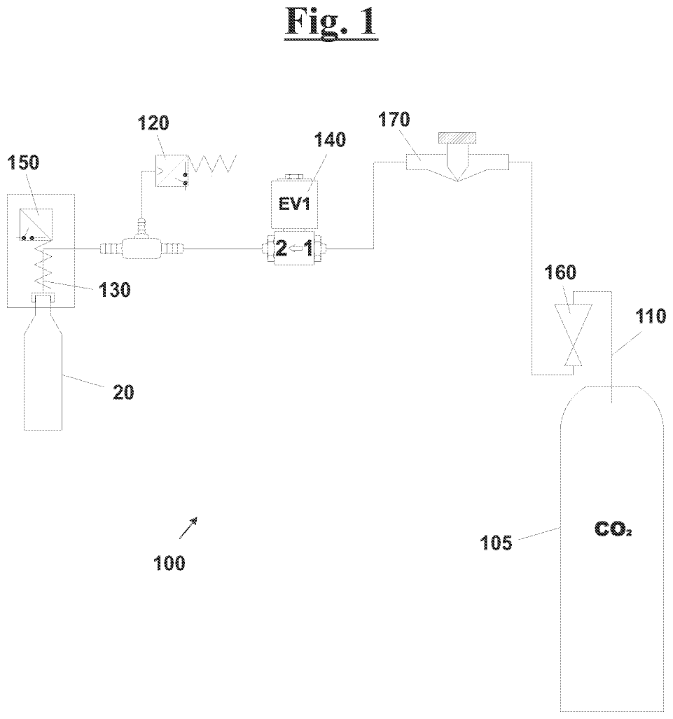

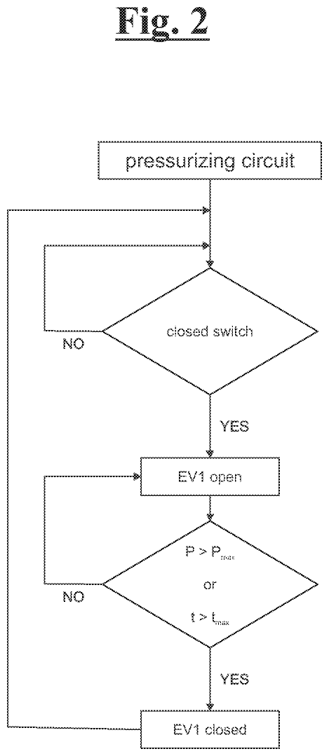

With reference to FIGS. 1 and 2, the device 10 for preserving a liquid inside a container 20, according to the present invention, comprises a pressurizing circuit 100 arranged to pressurize the container 20.

In particular, the pressurizing circuit 100 comprises a fastening element 110 arranged to connect the pressurizing circuit 100 to a source of inert gas 105, a pressure switch 120 and an injection duct 130 arranged to be connected to the container 20 for introducing the inert gas in the container 20. In particular, the inert gas introduced into the container 20 is mainly carbon dioxide.

The pressurizing circuit 100 then comprises a solenoid valve EV1 140 arranged to switch between an open configuration, where the injection duct 130 allows the introduction of the inert gas in the container 20, and a closed configuration, where the injection duct 130 does not allow the introduction of the inert gas in the container 20.

The pressurizing circuit 100 also comprises an electric switch 150 arranged to bring the solenoid valve EV1 140 in the open configuration, when the injection duct 130 is connected to the container 20, and to bring the solenoid valve EV1 140 in the closed configuration, when the injection duct 130 is not connected to the container 20.

The pressurizing circuit 100 finally comprises a control unit arranged to bring the solenoid valve EV1 140 in the closed configuration when the pressure switch 120 verifies a pressure in the container 20 higher than a predetermined threshold value Pₘₐₓ.

The control unit is also arranged to bring the solenoid valve EV1 140 in the closed configuration if it remains in the open configuration for a time longer than a predetermined threshold value tₘₐₓ.

This way, the present invention provides that the solenoid valve EV1 140 is brought into the closed configuration alternatively:
in case that the container is disconnected from the injection duct;
in case that the pressure in the container exceeds a predetermined threshold value Pₘₐₓ;
in case that the solenoid valve EV1 remains in the open configuration for a time longer than a predetermined threshold value tₘₐₓ.

In this way, the present invention allows to obtain the correct pressure inside the container 20 while avoiding the dispersion of inert gas in the event of component malfunction.

In particular, with reference to FIG. 2, when the container 20 is connected to the injection duct 130, the electric switch closes and the solenoid valve EV1 140 switches to the open configuration, allowing the introduction of gas in the container 20.

If the pressure switch works correctly, the solenoid valve EV1 140 passes into the closed configuration upon reaching the condition P=Pₘₐₓ, i.e. the desired pressure value for correct storage of the liquid.

In case, instead, that there is a malfunction of the pressure switch, the solenoid valve EV1 140 automatically switches to the closed configuration upon reaching the condition t=tₘₐₓ, blocking the flow of the inert gas and preventing its dispersion into the environment.

This closing of the solenoid valve EV1 140 also occurs even if the container 20 is disconnected before the condition P=Pₘₐₓ is reached. This occurs either thanks to the automatic opening of the electric switch that opens the circuit or, in the event of a switch malfunction, when the condition t=tₘₐₓ is reached.

With reference to FIG. 1, the pressurizing circuit 100 also comprises a flow reducer 170 arranged to prevent pressure peaks in the pressurizing circuit 100. This way, it is avoided that a pressure peak in the circuit causes the pressure switch 120 to be activated by mistake, thus controlling the closing of the solenoid valve EV1 140 when the inert gas pressure in the container 20 is not yet sufficient.

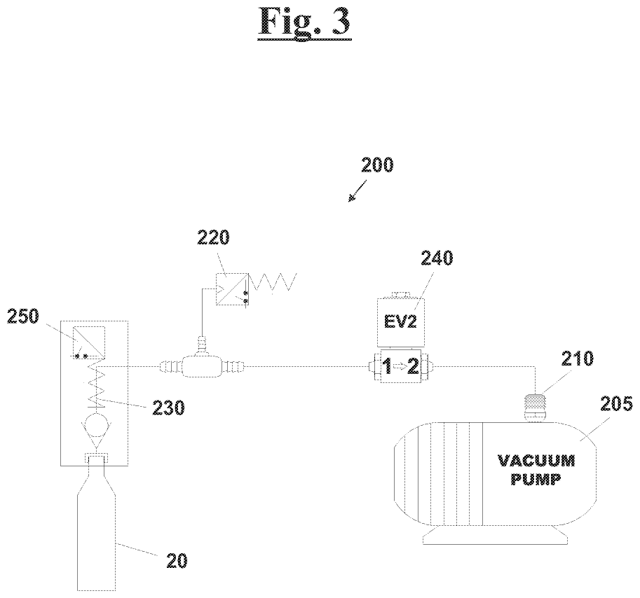

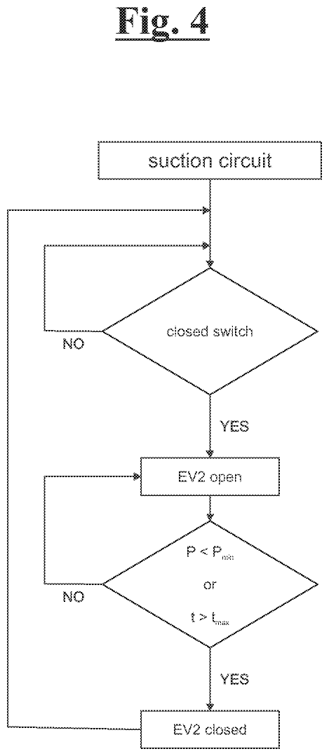

With reference to FIGS. 3 and 4, according to another aspect of the invention, the device 10 for preserving a liquid inside a container 20 comprises a suction circuit 200 arranged to reduce the pressure in the container 20.

In particular, the suction circuit 200 comprises a fastening element 110 arranged to connect the suction circuit 200 to a vacuum pump 205, a vacuum switch 220 and a suction duct 230 arranged to be connected to the container for causing the suction of gas from the container 20. In particular, the gas sucked by the container 20 is mainly oxygen.

The suction circuit 200 then comprises a solenoid valve EV2 240 arranged to switch between an open configuration, in which the suction duct 230 allows the suction of gas from the container 20, and a closed configuration, in which the suction duct 230 does not allow the suction of gas from the container 20.

The suction circuit 200 also comprises an electric switch 250 arranged to bring the solenoid valve EV2 240 in the open configuration, when the suction duct 230 is connected to the container 20, and to bring the solenoid valve EV2 240 in the closed configuration, when the suction duct 230 is not connected to the container 20.

The suction circuit 200 finally comprises a control unit arranged to bring the solenoid valve EV2 240 in the closed configuration when the vacuum switch 220 verifies a pressure in the container 20 lower than a predetermined threshold value Pₘᵢₙ.

The control unit is also arranged to bring the solenoid valve EV2 240 in the closed configuration if it remains in the open configuration for a time longer than a predetermined threshold value tₘₐₓ.

This way, the present invention provides that the solenoid valve EV2 240 is brought into closed configuration alternatively:
in case that the container is disconnected from the suction duct;
in case that the pressure in the container is lower than a predetermined threshold value Pₘᵢₙ;
in case that the solenoid valve EV2 remains in the open configuration for a time longer than a predetermined threshold value tₘₐₓ.

In this way, the present invention allows to obtain the correct removal of gas from the container while avoiding the creation of an excessive vacuum in case of malfunction of the vacuum switch.

In particular, with reference to FIG. 4, when the container 20 is connected to the suction duct 230, the electric switch closes and the solenoid valve EV2 240 switches to the open configuration, allowing the suction of gas from the container 20.

If the vacuum switch works correctly, the solenoid valve EV2 240 then passes in the closed configuration upon reaching the condition P=Pₘᵢₙ, i.e. that is the desired vacuum level for correct storage of the liquid.

In case, instead, that there is a malfunction of the vacuum switch, the solenoid valve EV2 240 automatically switches to the closed configuration when the condition t=tₘₐₓ is reached, avoiding the formation of a high vacuum which would involve the suction of sulfur dioxide SO₂ and dissolved carbon dioxide CO₂, altering the original taste of the wine.

This closure of the solenoid valve EV2 240 also occurs even if the container 20 is disconnected before the condition P=Pₘᵢₙ is reached. This occurs either thanks to the automatic opening of the electric switch that opens the circuit or, in the event of a switch malfunction, when the condition t=tₘₐₓ is reached.

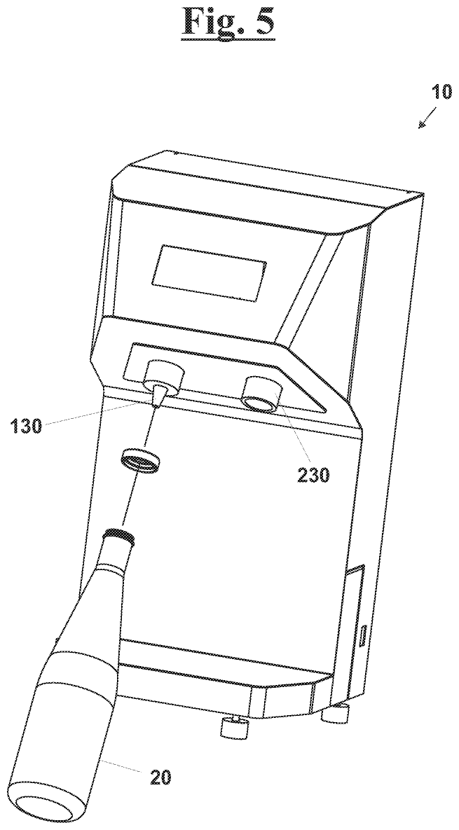

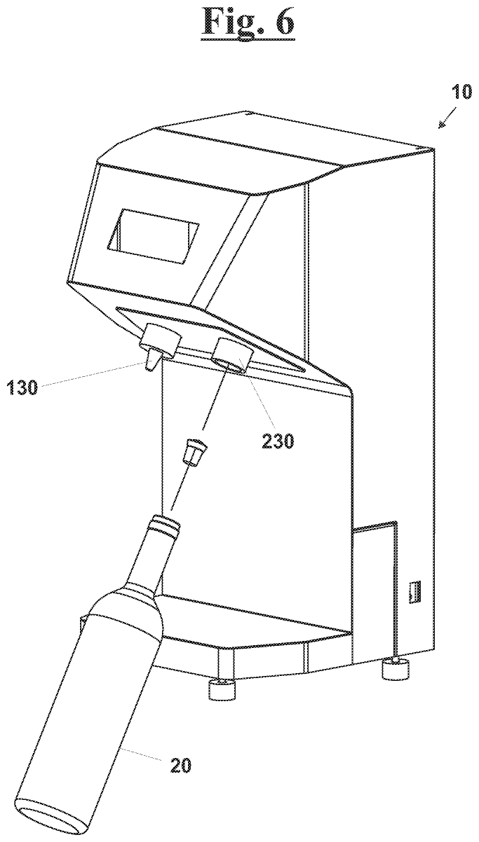

In the FIGS. 5 and 6 a possible embodiment of the invention is shown, in which the device 10 for preserving a liquid inside a container 20 comprises both a pressurizing circuit 100, as shown in FIGS. 1 and 2, and a suction circuit 200, as shown in FIGS. 3 and 4.

In particular, in FIG. 5 a container 20 is shown, for example a bottle of vino, in the procedure of connection to the injection duct 130, while in FIG. 6 the same container is shown in the procedure of connection to the suction duct 230.

Although FIGS. 5 and 6 show an embodiment where the device 10 comprises both the pressurizing circuit 100 and the suction circuit 200, the present invention also provides embodiments where the device 10 comprises only the pressurizing circuit 100 or only the suction circuit 200.

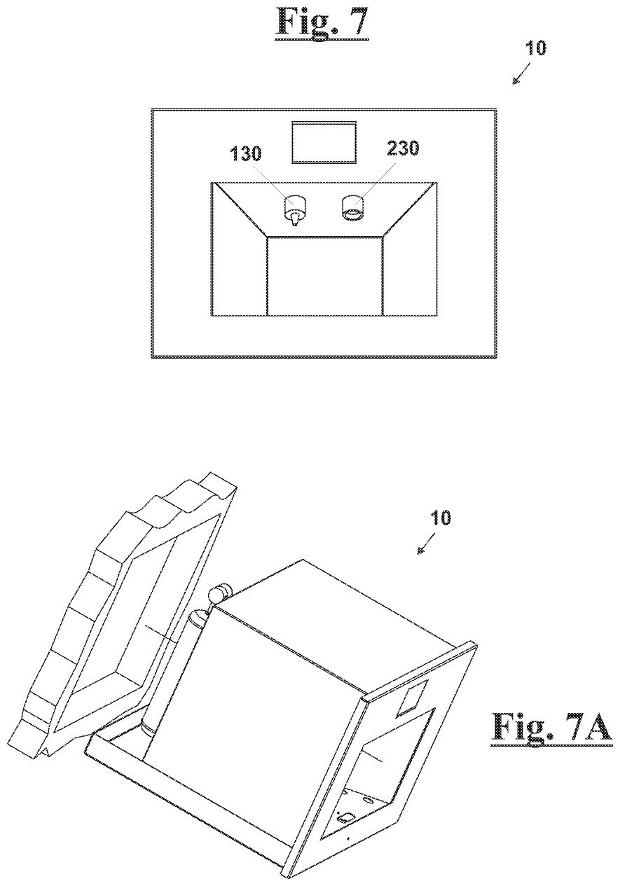

In the FIGS. 7 and 7A an embodiment of the invention is shown in which the device 10 is arranged for being recessed into a wall, reducing the overall dimensions and being optimal, for example, for insertion inside a domestic kitchen.

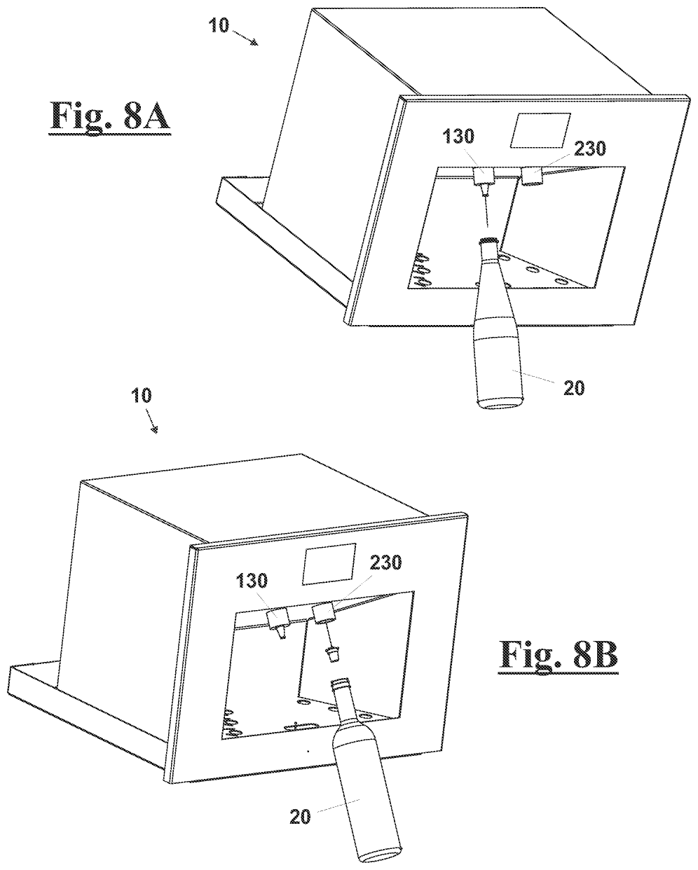

In particular, with reference to FIGS. 8A and 8B, also in this embodiment the device 10 for preserving a liquid inside a container 20 comprises both a pressurizing circuit 100, as shown in FIGS. 1 and 2, and a suction circuit 200, as shown in FIGS. 3 and 4.

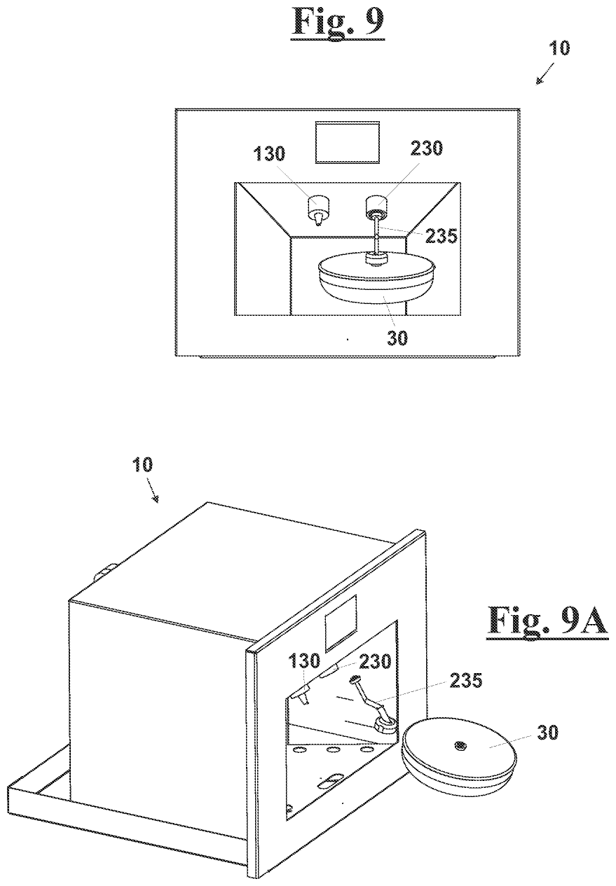

FIGS. 9 and 9A show a mode of use of the device in which the presence of an adapter 235 is provided which allows the suction duct 230 of the suction circuit 200 to be connected to a container designed for vacuum-packing food. In this way, the present invention allows the same suction circuit 200 to be used also for food preservation.

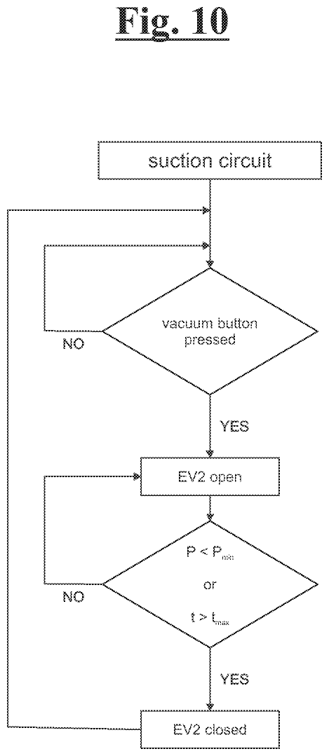

FIG. 10 shows a block diagram of the operation of the suction circuit, in the mode of use for creating vacuum in a food container.

In particular, in this mode, the present invention provides that the user connects the food container 30 to the suction duct 230 by means of the adapter 235. When the user presses the button relating to the vacuum sealer for food, the control unit manages the creation of the vacuum in the food container 30 in a similar way to that described above for the vacuum of the liquid container 20.

Therefore, the solenoid valve EV2 240 closes and the process stops automatically:
in the event that the container 30 is disconnected from the suction duct 230;
in the event that the pressure in the container 30 is lower than a predetermined threshold value Pₘᵢₙ;
in the event that the EV2 240 solenoid valve remains in the open configuration for a time greater than a predetermined threshold value tₘₐₓ.

In a further embodiment of the invention, not shown in the figures, the suction circuit 200 does not require the presence of the solenoid valve EV2 240. In this solution, the vacuum pump 205 is an electric pump suitable for switching between an open configuration and a closed configuration by means of the electric switch 250 or the control unit, in a completely similar way to what was previously described regarding the solenoid valve EV2 240.

The foregoing description exemplary embodiments of the invention will so fully reveal the invention according to the conceptual point of view, so that others, by applying current knowledge, will be able to modify and/or adapt for various applications such embodiment without further research and without parting from the invention, and, accordingly, it is therefore to be understood that such adaptations and modifications will have to be considered as equivalent to the specific embodiments. The means and the materials to realise the different functions described herein could have a different nature without, for this reason, departing from the field of the invention. It is to be understood that the phraseology or terminology that is employed herein is for the purpose of description and not of limitation.

1. A device for preserving a liquid inside a container, said device comprising a pressurizing circuit arranged to pressurize said container, said pressurizing circuit comprising:
a fastening element arranged to connect said pressurizing circuit to a source of inert gas;
a pressure switch;
an injection duct arranged to be connected to said container for introducing said inert gas in said container;
a solenoid valve EV1 arranged to switch between an open configuration, in which said injection duct allows introduction of said inert gas in said container, and a closed configuration, in which said injection duct does not allow the introduction of said inert gas in said container;
an electric switch arranged to bring said solenoid valve EV1 in said open configuration, when said injection duct is connected to said container, and to bring said solenoid valve EV1 in said closed configuration, when said injection duct is not connected to said container; and
a control unit arranged to bring said solenoid valve EV1 in said closed configuration when said pressure switch verifies a pressure in said container higher than a predetermined threshold value Pₘₐₓ;
said device, wherein said control unit is also arranged to bring said solenoid valve EV1 in said closed configuration if said solenoid valve EV1 remains in said open configuration for a time longer than a predetermined threshold value tₘₐₓ.

2. The device for preserving a liquid inside a container, according to claim 1, wherein said pressurizing circuit also comprises a pressure reducer arranged to adjust the pressure of inert gas in said pressurizing circuit.

3. The device for preserving a liquid inside a container, according to claim 1, wherein said pressurizing circuit also comprises a flow reducer arranged to prevent pressure peaks in said pressurizing circuit.

4. The device for preserving a liquid inside a container, according to claim 1, wherein said inert gas is carbon dioxide.

5. A device for preserving a liquid inside a container, said device comprising a suction circuit arranged to reduce pressure in said container, said suction circuit comprising:
a fastening element arranged to connect said suction circuit to a vacuum pump;
a vacuum switch;
a suction duct arranged to be connected to said container for causing suction of gas from said container;
a solenoid valve EV2 arranged to switch between an open configuration, in which said suction duct allows the suction of gas from said container, and a closed configuration, in which said suction duct does not allow the suction of gas from said container;
an electric switch arranged to bring said solenoid valve EV2 in said open configuration, when said suction duct is connected to said container, and to bring said solenoid valve EV2 in said closed configuration, when said suction duct is not connected to said container; and
a control unit arranged to bring said solenoid valve EV2 in said closed configuration when said vacuum switch verifies a pressure in said container lower than a predetermined threshold value Pₘᵢₙ;
said device, wherein said control unit is also arranged to bring said solenoid valve EV2 in said closed configuration if said solenoid valve EV2 remains in said open configuration for a time longer than a predetermined threshold value tₘₐₓ.

6. A device for preserving a liquid inside a container, according to claim 5, wherein an adapter is also provided for the connection between said suction duct and a food container, in order to suck in gas from said food container.

7. A device for preserving a liquid inside a container, said device comprising:
said pressurizing circuit according to claim 1; and
a suction circuit arranged to reduce pressure in said container, said suction circuit comprising:
a fastening element arranged to connect said suction circuit to a vacuum pump;
a vacuum switch;
a suction duct arranged to be connected to said container for causing suction of gas from said container;
a solenoid valve EV2 arranged to switch between an open configuration, in which said suction duct allows the suction of gas from said container, and a closed configuration, in which said suction duct does not allow the suction of gas from said container;
an electric switch arranged to bring said solenoid valve EV2 in said open configuration, when said suction duct is connected to said container, and to bring said solenoid valve EV2 in said closed configuration, when said suction duct is not connected to said container; and
a control unit arranged to bring said solenoid valve EV2 in said closed configuration when said vacuum switch verifies a pressure in said container lower than a predetermined threshold value Pₘᵢₙ.

8. The device for preserving a liquid inside a container, according to claim 7, wherein said device is arranged to be recessed into a wall.

9. A device for preserving a liquid inside a container, said device comprising a suction circuit arranged to reduce pressure in said container, said suction circuit comprising:
a vacuum switch;
a suction duct arranged to be connected to said container for causing suction of gas from said container;
a vacuum pump connected to said suction circuit by means of a fastening element, said vacuum pump arranged to switch between an open configuration, in which said suction duct allows the suction of gas from said container, and a closed configuration, in which said suction duct does not allow the suction of gas from said container;
an electric switch arranged to bring said vacuum pump in said open configuration, when said suction duct is connected to said container, and to bring said vacuum pump in said closed configuration, when said suction duct is not connected to said container; and
a control unit arranged to bring said vacuum pump in said closed configuration when said vacuum switch verifies a pressure in said container lower than a predetermined threshold value Pₘᵢₙ;
said device wherein said control unit is also arranged to bring said vacuum pump in said closed configuration if said vacuum pump remains in said open configuration for a time longer than a predetermined threshold value tₘₐₓ.

10. A device for preserving a liquid inside a container, said device comprising:
said pressurizing circuit according to claim 2; and
a suction circuit arranged to reduce pressure in said container, said suction circuit comprising:
a fastening element arranged to connect said suction circuit to a vacuum pump;
a vacuum switch;
a suction duct arranged to be connected to said container for causing suction of gas from said container;
a solenoid valve EV2 arranged to switch between an open configuration, in which said suction duct allows the suction of gas from said container, and a closed configuration, in which said suction duct does not allow the suction of gas from said container;
an electric switch arranged to bring said solenoid valve EV2 in said open configuration, when said suction duct is connected to said container, and to bring said solenoid valve EV2 in said closed configuration, when said suction duct is not connected to said container; and
a control unit arranged to bring said solenoid valve EV2 in said closed configuration when said vacuum switch verifies a pressure in said container lower than a predetermined threshold value Pₘᵢₙ.

11. A device for preserving a liquid inside a container, said device comprising:
said pressurizing circuit according to claim 3; and
a suction circuit arranged to reduce pressure in said container, said suction circuit comprising:
a fastening element arranged to connect said suction circuit to a vacuum pump;
a vacuum switch;
a suction duct arranged to be connected to said container for causing suction of gas from said container;
a solenoid valve EV2 arranged to switch between an open configuration, in which said suction duct allows the suction of gas from said container, and a closed configuration, in which said suction duct does not allow the suction of gas from said container;
an electric switch arranged to bring said solenoid valve EV2 in said open configuration, when said suction duct is connected to said container, and to bring said solenoid valve EV2 in said closed configuration, when said suction duct is not connected to said container; and
a control unit arranged to bring said solenoid valve EV2 in said closed configuration when said vacuum switch verifies a pressure in said container lower than a predetermined threshold value Pₘᵢₙ.

12. A device for preserving a liquid inside a container, said device comprising:
said pressurizing circuit according to claim 4; and
a suction circuit arranged to reduce pressure in said container, said suction circuit comprising:
a fastening element arranged to connect said suction circuit to a vacuum pump;
a vacuum switch;
a suction duct arranged to be connected to said container for causing suction of gas from said container;
a solenoid valve EV2 arranged to switch between an open configuration, in which said suction duct allows the suction of gas from said container, and a closed configuration, in which said suction duct does not allow the suction of gas from said container;
an electric switch arranged to bring said solenoid valve EV2 in said open configuration, when said suction duct is connected to said container, and to bring said solenoid valve EV2 in said closed configuration, when said suction duct is not connected to said container; and
a control unit arranged to bring said solenoid valve EV2 in said closed configuration when said vacuum switch verifies a pressure in said container lower than a predetermined threshold value Pₘᵢₙ.

13. The device for preserving a liquid inside a container, according to claim 10, wherein said device is arranged to be recessed into a wall.

14. The device for preserving a liquid inside a container, according to claim 11, wherein said device is arranged to be recessed into a wall.

15. The device for preserving a liquid inside a container, according to claim 12, wherein said device is arranged to be recessed into a wall.
